(19) United States
(12) Patent Application Publication
(10) Pub. No.: US 2026/0169163 A1
(43) Pub. Date: Jun. 18, 2026

(54) Method for measuring the distance between a location and an object

(71) Applicants: Andreas Perger, Wien (AT); Leica Camera AG, Wetzlar (DE)

(72) Inventor: Andreas Perger, Wien (AT)

(21) Appl. No.: 19/367,679

(22) Filed: Oct. 23, 2025

(30) Foreign Application Priority Data
Oct. 24, 2024 (AT) A50849/2024

(51) Int. Cl. G01S 17/14; G01B 11/02; G01C 3/08

(52) U.S. Cl. CPC G01S 17/14; G01B 11/026; G01C 3/08

(57) ABSTRACT

A method for measuring the distance between a location and an object is provided, in which a plurality of main light pulses is emitted from the location by a transmitter, wherein when a main light pulse is emitted, a main sampling interval is started by an A/D converter in order to sample light pulses reflected by the object, whereby sampling values are obtained, in which between the emission of two main light pulses emitted one after the other an intermediate sampling interval is started by the A/D converter to sample light pulses reflected from the object, an intermediate light pulse being emitted during the intermediate sampling interval.

### BACKGROUND OF THE INVENTION

The invention relates to a method for measuring the distance between a location and an object, in which a plurality of main light pulses is emitted from the location by a transmitter, wherein when a main light pulse is emitted, a main sampling interval is started by an A/D converter in order to sample light pulses reflected by the object, whereby sample values are obtained.

The invention further relates to a device for measuring the distance between a location and an object, comprising a transmitter which is designed to emit a plurality of main light pulses one after the other, and an A/D converter which is designed to start a main sampling interval when a main light pulse is emitted in order to sample light pulses reflected by the object and to obtain sample values.

Since the 1990s, laser rangefinders based on the pulse time-of-flight method for carrying out procedures of the type mentioned above have also become widely used in the consumer sector. They are used primarily in golf and hunting, but also by sport shooters, in water sports and other recreational activities. The measuring range of such rangefinders is a few hundred meters to a few kilometers and the accuracy is typically around one meter, which is usually sufficient for the aforementioned applications. Suitable targets are usually those that reflect diffusely rather than directly, such as trees and bushes, but also artificial objects. For consumer applications, it is of course important that the lasers used are eye-safe.

The price of such a product is also important and crucial for mass distribution. Therefore, it is important to ensure that the rangefinder components can be manufactured cost-effectively. Laser rangefinders for the above-mentioned applications typically consist of the electronic part (including optoelectronic components), as well as optical and mechanical parts. While the mechanical parts hold all components securely in place and protect them from external influences, the optical components (generally consisting of the objective, inversion system, and eyepiece, as well as optics for transmitting and receiving the laser radiation) serve to visualize and target the measured object. The optical system can be designed for monocular or binocular observation.

The electronic component essentially consists of a transmitter and a receiver for the laser beam, as well as a signal processing and display unit. The signal processing unit also integrates the operation, control of the display, and power supply. Additional components such as an inclinometer, compass, temperature and air pressure sensors, and the like can also be added. Laser diodes have become established as transmitters, while avalanche photodiodes (APDs) have become established as the receivers, both with associated electronic circuits. Avalanche photodiodes are diodes with an internal amplification mechanism, enabling them to detect even weak optical signals and even individual photons. Furthermore, the transmitter and receiver require optics to collimate the laser beam toward the target and to project the laser light reflected from the target onto the receiver, wherein the aforementioned observation optics can also be used if necessary. Optical components are also required to reflect the display into the observation beam path (see EP 1 069 442 B1).

As mentioned, the rangefinders described here operate according to the pulse-time-of-flight method, which means they measure the time it takes for a laser pulse to travel from the transmitter to the target and back to the receiver. For this purpose, the receiver signal is sampled and digitized after a laser pulse has been emitted, and the resulting digital data is evaluated to determine the distance to the target object.

At large distances to be measured, which can be several kilometers, the light pulses reflected from the target and hitting the receiver are very weak and can be completely lost in the unavoidable noise on the receiver side, which comes primarily from the ambient light, but also from the photodiode and the subsequent amplifier. For this reason, a process has become established in which a large number of laser pulses (usually several thousand) are emitted and the associated received signals are added synchronously. Per sampling cycle, i.e. per unit of time, the received signals are added up, so that per sampling cycle a number of individual sampling values corresponding to the number of light pulses emitted is obtained, which are added together. The useful signal resulting from the reflected laser pulses increases linearly with the number of pulses; however, for statistical reasons, the noise is only based on the root of the pulse number. The signal-to-noise ratio improved in this way makes it possible to measure distances that cannot be measured with a single pulse of the same strength. Such a method is described in detail in EP 1 078 281 B1. What is important here is that the generation of the transmission pulse and the sampling take place synchronously, which is best achieved by deriving both clock signals necessary for this from the clock signal of a microcontroller. The sample values, which are supplied by a fast A/D converter, are stored either in an external memory or directly in the RAM of the microcontroller so that they can later be subjected to the aforementioned summation. In the case of storage in an external RAM, the addresses of this memory chip are also controlled synchronously with the clock signals mentioned either by a synchronous counter or, even better, by the microcontroller itself. The sampling frequency of the A/D converter is usually selected to be a few 10 MHz. It must not be too low in order to obtain a sufficient number of “base points” on the received signal. However, a sampling frequency that is too high has an impact on the component costs and the resulting amounts of data, which have to be processed in a short time. The position of the received pulse within this group of points called a “histogram” reflects the distance.

In the case of a sampling frequency of, for example, 25 MHz, the distance between the sampling times corresponds to a distance difference of 6 meters. If you are content with determining the position of the maximum of the received pulse within the histogram, you get a distance resolution of 6 meters. In most cases this is not satisfactory. Therefore, interpolation is used to determine, for example, the 50% point of the rising or falling edge of the pulse or the position of the center of gravity of the pulse. Further interpolation algorithms are conceivable.

As mentioned, the sampling frequency is chosen primarily for cost reasons, so that the received pulse is represented by a few sample values. There are usually around three to four sampling points that lie between the 50% points of the rising and falling edges. This allows an accuracy of around one meter to be achieved.

However, higher accuracy is often desired, particularly at close range up to a few hundred meters. Since there is usually a high signal-to-noise ratio in the close range and the statistical fluctuations in the measured values are therefore small, measurement errors are mainly due to the insufficient number of sampling points distributed over the received pulse, since systematic errors arise when interpolating around the 50% point of the rising edge of the pulse. The highest sample value generally does not correspond exactly to the maximum of the analog pulse, which makes the calculation of the 50% threshold inaccurate. The search for the 50% point on the rising edge by interpolation between two neighboring samples also has a residual error, since the analog pulse in this area is usually not straight but curved. Increasing the sampling frequency in order to increase the accuracy is not possible for cost reasons.

### SUMMARY OF THE INVENTION

It is therefore an object of the invention to provide a method that allows greater accuracy, especially in the close range, of distance measurement. In particular, no more light pulses should be necessary compared to the prior art.

### BRIEF DESCRIPTION OF DRAWINGS

FIG. 1 shows schematically the sequence of a distance measurement according to the prior art.

FIG. 2A shows a histogram of distance measurements according to the prior art.

FIG. 2B shows a histogram of distance measurements according to the prior art.

FIG. 2C shows a histogram of distance measurements according to the prior art.

FIG. 3 shows schematically the sequence of a distance measurement according to the invention.

FIG. 4 shows a histogram of a distance measurement according to the invention.

### DETAILED DESCRIPTION OF THE INVENTION

According to the invention, a method of the type mentioned at the outset is provided, wherein between the emission of two main light pulses emitted one after the other an intermediate sampling interval is started by the A/D converter to sample light pulses reflected from the object, an intermediate light pulse being emitted during the intermediate sampling interval. Here, as already known, a main light pulse is first sent out and, synchronously, a main sampling interval is started by an A/D converter. The main sampling interval has a specific time length corresponding to the desired maximum distance and includes several sampling cycles. After the (defined) duration of the main sampling interval has been reached, sampling is stopped. The main light pulse is reflected by the object and partially detected by a receiver, for example an (avalanche) photodiode. The signals detected by the receiver are then preferably fed to an amplifier, which amplifies the signals and then transmitted to the A/D converter (analog-digital converter), which samples and digitizes the signals in a clocked manner. This results in a series of measured values in which a signal with a specific signal strength was determined for each sampling cycle. In order to improve the method, a plurality of main light pulses is emitted one after the other, with a main sampling interval being started when each main light pulse is emitted. There is a defined period of time between the emission of two main light pulses emitted one after the other. The next main light pulse is only emitted after the end of the previous main sampling interval. The duration between the emission of two main light pulses (emitted one after the other) is therefore longer than the duration of a main sampling interval. The digital data is then saved and evaluated to obtain the desired distance.

In addition to the main light pulses, the next light pulse, namely an intermediate light pulse, is emitted between two main light pulses. Here, after completion of a first main sampling interval, an intermediate sampling interval is started and an intermediate light pulse is emitted during the intermediate sampling interval. The intermediate sampling interval has a specific time length that corresponds to the desired maximum distance and includes several sampling cycles. The intermediate light pulse is emitted at a time offset from the intermediate sampling interval. An intermediate light pulse is therefore emitted during the running of an intermediate sampling interval and is not, like the main light pulses, emitted at the same time (synchronously) with the start of a main sampling interval. After the intermediate sampling interval has ended, a second main sampling interval is started and at the same time a second main light pulse is emitted. If, after the end of the second main sampling interval, the next intermediate light pulse is sent again during an intermediate sampling interval and the next main light pulse is sent again at the beginning of a main sampling interval and so on, this results in a set of two series of values received by the receiver, for example an avalanche photodiode, and processed by the A/D converter, which can be displayed as a histogram, for example. The first series of values is formed by the values determined during the main sampling intervals and the second series of values is formed by the values determined during the intermediate sampling intervals. The series of values or histograms can be put together and produce a histogram with twice the temporal resolution compared to a conventional method in which only main light pulses are emitted synchronously with the beginning of a sampling interval.

The duration of the main sampling intervals and the duration of the intermediate sampling intervals are preferably essentially constant and more preferably essentially the same. The time period between the end of a main sampling interval and the beginning of an intermediate sampling interval is preferably constant and further preferably corresponds to the time period between the end of an intermediate sampling interval and the beginning of a main sampling interval.

It is preferably provided that two or more intermediate light pulses are emitted between two successive main light pulses. Here, between two main light pulses, two or more intermediate sampling intervals are carried out one after the other and one intermediate light pulse is emitted during an intermediate sampling interval. The time period between the end of a first intermediate sampling interval and the beginning of a second intermediate sampling interval is preferably constant and further preferably corresponds to the time period between the end of a main sampling interval and the beginning of an intermediate sampling interval and the time period between the end of an intermediate sampling interval and the beginning of a main sampling interval. This further increases the accuracy of the procedure. However, it turns out that the insertion of one intermediate light pulse between two main light pulses together with the corresponding sampling enables distance measurement accuracy in the decimeter range.

Light pulses, in particular main light pulses and intermediate light pulses, are preferably understood to mean laser pulses. The duration of the light pulses is usually in the range of a few 10 ns. The light pulses are directed onto the object as an (approximately) parallel beam, for example using a lens. The main light pulses and the intermediate light pulses are preferably essentially the same and therefore preferably have the same duration and strength.

Furthermore, the main light pulses and the intermediate light pulses are preferably emitted by the same transmitter.

The sampling by the A/D converter is clocked and therefore includes several sampling cycles. The sampling can take place, for example, at a frequency of 10 MHz.

It is preferably provided that the intermediate light pulses are each emitted essentially in the middle of a sampling cycle of the sampling, i.e. the intermediate sampling interval. The intermediate light pulses are emitted after half the duration of a sampling cycle.

In order to achieve the same signal-to-noise ratio as with a known method, twice the number (or three, four times, etc., if one aims for an even higher temporal resolution) of light pulses would have to be emitted. However, since the pulse energy and number of pulses are limited due to eye safety, the higher resolution initially comes at the expense of the signal-to-noise ratio and thus the range if the same number of light pulses are emitted as with a conventional method. To avoid this, one can either provide user-selectable measurement modes for either increased accuracy or a longer range, or provide automatic switching between these methods. It is therefore preferably provided that before the main light pulses and intermediate light pulses are emitted, a large number of test light pulses are emitted by the transmitter and corresponding test sample values are received by the receiver and further processed accordingly. Here, a number of test light pulses are first emitted with main light pulses, emitted synchronously with the start of a main sampling intervals and, if necessary, intermediate light pulses. All test light pulses are preferably emitted synchronously at the beginning of a main sampling interval. If a received signal (target echo) is observed in the close range with a sufficiently high signal-to-noise ratio, main light pulses and intermediate light pulses are emitted during the following measurement. So every second laser pulse is used to determine intermediate sampling values. In this case, the test sampling values are preferably no longer used to determine the distance. This increases the resolution and thus the accuracy of the measurement at close range. However, if no received signal (target echo) is observed in the close range with a sufficiently high signal-to-noise ratio, all light pulses are emitted synchronously with the start of a main sampling interval and are used to achieve the highest possible signal-to-noise ratio. Intermediate light pulses are not emitted here. In this case, the test light pulses and the subsequently emitted main light pulses are evaluated together; preferably in a common histogram.

It is therefore preferably provided that if a target echo was detected in the test sampling values sampled by the receiver, a defined number of main light pulses and intermediate light pulses are emitted.

For example, if the rangefinder is normally designed so that 4000 laser pulses are emitted for one measurement, in this preferred embodiment, for example, 1000 test light pulses are initially sent synchronously with the start of a sampling interval. The associated sample values are added up to form a histogram as described above. In this histogram, for example, a target is searched for in the range of 10 to 200 m. If a target has been found here, 1500 main light pulses without delay and 1500 intermediate light pulses with a delay of, for example, half a sampling interval are sent and added up, with non-delayed and delayed light pulses always being sent alternately. The histogram over the first 1000 test light pulses is no longer used.

If no target in the range of 10 to 200 m was found in the histogram over the first 1000 pulses, a further 3000 pulses are sent without delay and added to the original histogram (the one over 1000 pulses), so that there is no loss in signal-to-noise ratio for targets that are further away.

This approach makes it possible to select and use the appropriate measuring method depending on the situation in order to be able to determine the distance as precisely as possible.

It is preferably provided that the sample values of the main light pulses and the sample values of the intermediate light pulses are evaluated in a common histogram. This enables the desired distance to be determined as precisely as possible.

The time shift of an emitted intermediate light pulse compared to the start of the intermediate sampling interval can be done using a separate circuit. However, it is particularly preferred to accomplish this using a (micro) controller alone. The shift between a main light pulse and the corresponding intermediate light pulse occurs here by inserting a delay of one command cycle from the controller. This implementation is carried out solely via the software and does not cause any additional costs due to structural adjustments to the rangefinder. It is therefore preferably provided that the emission of the main light pulses and the intermediate light pulses is controlled using a (micro) controller. Particularly preferably, the A/D converter is also controlled by the controller in order to ensure synchronous triggering of the emission of the light pulses and the sampling intervals. Here, a first signal from the microcontroller is used to start the intermediate sampling interval and a second signal to send out the intermediate light pulse. For the main light pulses, a signal is preferably used to trigger both the main light pulse and the main sampling interval.

To increase absolute accuracy, the distance offset of the range finder can be calibrated to compensate for sample variations. To do this, either before each measurement, light pulses are passed directly from the transmitter to the receiver instead of via the target, thereby determining the position of the received pulse in the histogram at distance 0, which, however, requires electro-optical or opto-mechanical switches, or one is content with carrying out a reference measurement at the end of the manufacturing process of the rangefinder by measuring on a target at a known distance and storing the distance thus obtained in the rangefinder. However, the latter method does not compensate for aging effects.

At small measuring distances, the distance measurement produces received signals that can be many orders of magnitude higher than at large distances. In order to avoid overdriving the receiver in the close range and thus reducing measurement accuracy, the transmission power of most versions of laser rangefinders is reduced (usually in steps). Furthermore, the internal gain of the receiver diode or that of the subsequent amplifier can also be reduced. It is advisable to carry out the distance offset calibration described above at all power and gain levels.

According to the invention, a device of the type mentioned at the outset is further provided, in which the A/D converter is designed to start an intermediate sampling interval between two main sampling intervals in order to sample light pulses reflected from the object and obtain sample values and the transmitter is designed to emit an intermediate light pulse during the intermediate sampling interval.

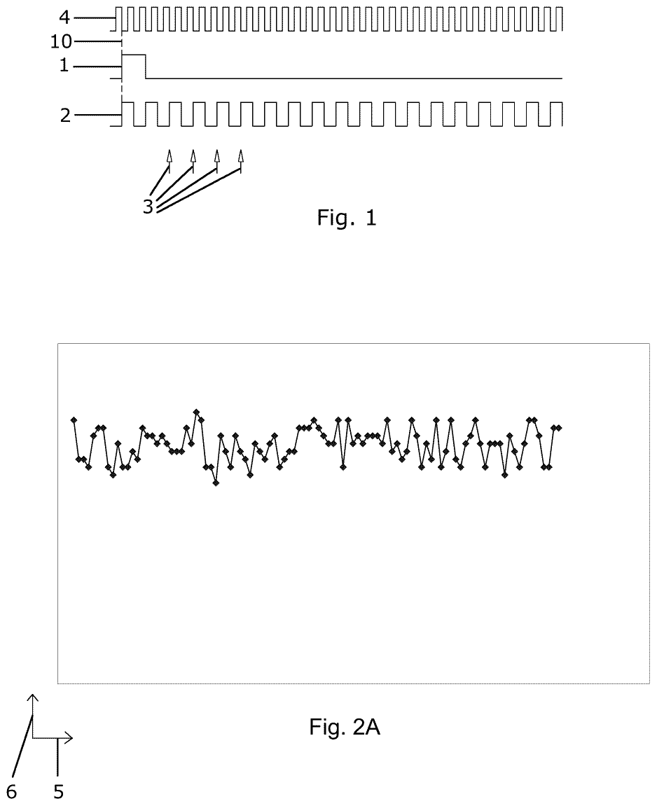

FIG. 1 shows the process of a distance measurement according to the prior art. 1 denotes a main light pulse that is emitted from the location in the direction of an object using a transmitter. At the same time as the main light pulse 1 is transmitted, a main sampling interval 2 with a defined frequency and a defined length is started by an A/D converter in order to read out the values received by a receiver, for example an avalanche photodiode, i.e. the reflections of the main light pulse 1. Sample values are determined and further processed at points 3 of the main sampling interval 2. Each sample value corresponds to a specific distance from the location. After a defined period of time, which corresponds to the maximum distance of the measurement, the main sampling interval 2 is ended and then a main light pulse 1 is sent out again and another main sampling interval 2 is started. This procedure is usually carried out several times to get a better result. The sample values obtained are summed up and then displayed, for example, in a histogram. In order to start the main light pulse 1 and the corresponding main sampling interval 2 simultaneously, a microcontroller with a clock signal 4 is provided, which uses the signal 10 to trigger or start both the main light pulse 1 and the sampling interval 2 synchronously.

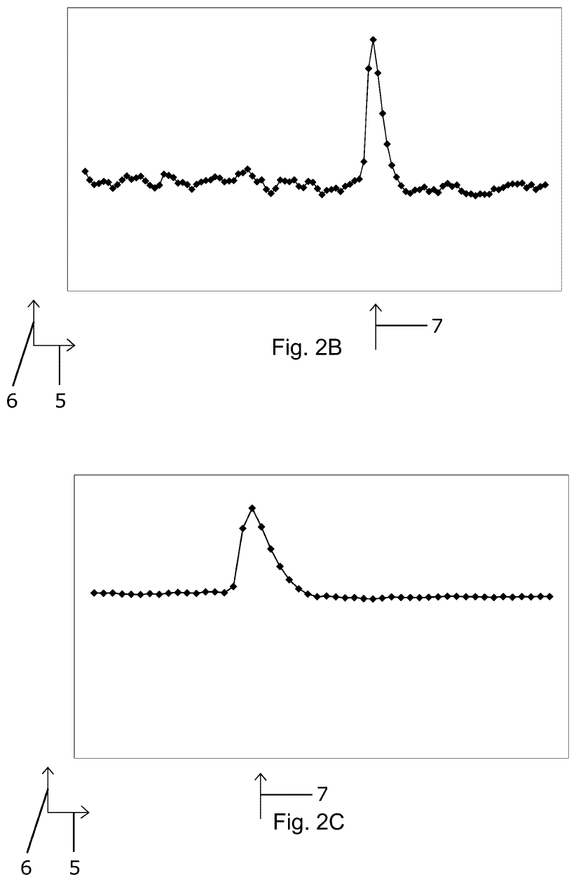

In FIG. 2a the result of a measurement with a single main light pulse 1 is shown in the form of a histogram. The time is plotted in the direction of the x-axis 5 and the received signal strength is plotted in the direction of the y-axis 6. Each point corresponds to a sample value. The measured values sampled by the A/D converter show no trace of a received target reflex.

FIG. 2b shows the result of a measurement with several thousand main light pulses 1, with the individual sample values being summed up. The values of the individual main light pulses 1, which were detected with the same sampling cycles, are added together. Each point therefore corresponds to the sum of the signals received at a sampling cycle during the main sampling interval 2. A significantly stronger signal can be seen in area 7. The distance to the target object can now be calculated from the temporal position of the maximum in area 7 in the direction of x-axis 5, which indicates the time period after which the signal was received, and the size of the signal strength in the y-direction 6, for example by interpolating the 50% point of the rising or falling edge of the pulse or by the position of the center of gravity of the pulse.

FIG. 2c shows the result of a further measurement with several thousand main light pulses 1, with a clearly stronger signal being visible in area 7.

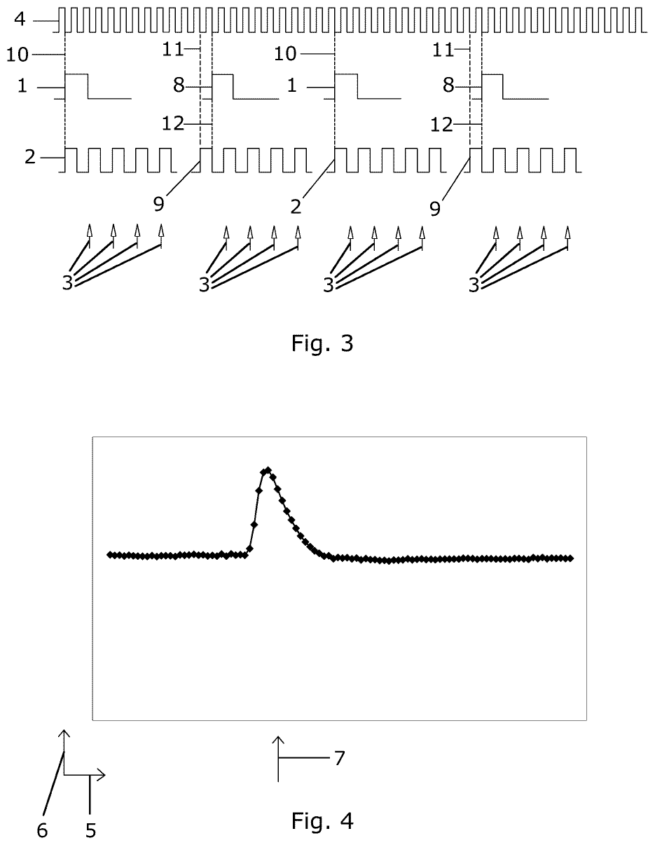

In FIG. 3, the sequence of a distance measurement according to the invention is shown. Here, the method is carried out according to the scheme shown in FIG. 1, with an intermediate light pulse 8, also by the transmitter, being emitted after the emission of a main light pulse 1, i.e. between two main light pulses 1. Before emitting the intermediate light pulse, an intermediate sampling interval 9 is started by the A/D converter. The intermediate light pulse 8 is emitted after half the duration of a sampling cycle of the intermediate sampling interval 9, i.e. during the intermediate sampling interval 9. At points 3 of the main sampling interval 2, the sample values of the reflections of the corresponding main light pulse 1 are now determined and at points 3 of the intermediate sampling interval 9, the sample values of the reflections of the corresponding intermediate light pulse 8 are determined and further processed. An intermediate light pulse 8 is emitted between two main light pulses 1. Accordingly, an intermediate sampling interval 9 is started and carried out between two successive main sampling intervals 2. In this example, two main sampling intervals 2 and one main light pulse 8 as well as two intermediate sampling intervals 9 and one intermediate light pulse 8 are shown. After the second intermediate sampling interval 9, a main sampling interval 2 is started again (not shown) and so on until the required number of light pulses and samples in the sampling intervals 2, 9 have been carried out. The signal 10 of the clock signal 4 of the microcontroller shown in dashed lines is used to send out the main light pulse 1 and to start the main sampling interval 2. On the other hand, the signal 11 of the clock signal 4 of the microcontroller shown in dashed lines is only used for starting the intermediate sampling interval 9 and a signal 12 of the clock signal 4 of the microcontroller shown in dashed lines is used for starting the intermediate light pulse 8. More than one intermediate light pulse 8 can also be emitted after a main light pulse 1 has been sent out. Here, between the main sampling intervals 2, the number of intermediate sampling intervals 9 corresponding to the number of intermediate light pulses 8 are carried out.

FIG. 4 shows the result of a measurement as shown in FIG. 2c, whereby in addition to the main light pulses 1, intermediate light pulses 8 were also emitted and sampled accordingly; according to the method as described in FIG. 3. It can be seen that, due to the intermediate light pulses 8, more measurement points have been obtained in the histogram, which means that the resolution, particularly in area 7, is better and the measurement is therefore more precise than the measurement shown in FIG. 2c.

1. A method for measuring the distance between a location and an object, in which a plurality of main light pulses is emitted from the location by a transmitter, wherein when a main light pulse is emitted, a main sampling interval is started by an A/D converter in order to sample light pulses reflected by the object, whereby sample values are obtained, characterized in that between the emission of two main light pulses emitted one after the other an intermediate sampling interval is started by the A/D converter to sample light pulses reflected from the object, an intermediate light pulse being emitted during the intermediate sampling interval.

2. The method according to claim 1, wherein two or more intermediate light pulses are emitted between two successive main light pulses.

3. The method according to claim 1, wherein the intermediate light pulses are each emitted essentially in the middle of a sampling cycle of the intermediate sampling interval.

4. The method according to claim 1, wherein that before the main light pulses and intermediate light pulses are emitted, a large number of test light pulses are emitted by the transmitter and corresponding test sample values are received by the receiver.

5. The method according to claim 4, wherein the number of main light pulses and intermediate light pulses to be emitted is determined based on the test sample values.

6. The method according to claim 1, wherein the sample values of the main light pulses and the sample values of the intermediate light pulses are evaluated in a common histogram.

7. The method according to claim 1, wherein the emission of the main light pulses and the intermediate light pulses is controlled using a controller.

8. A device for measuring the distance between a location and an object for carrying out a method according to claim 1, comprising a transmitter which is designed to emit a plurality of main light pulses one after the other, and an A/D converter which is designed to start a main sampling interval when a main light pulse is emitted in order to sample light pulses reflected by the object and to obtain sample values, characterized in that the A/D converter is designed to start an intermediate sampling interval between two main sampling intervals in order to sample light pulses reflected from the object and obtain sample values and the transmitter is designed to emit an intermediate light pulse during the intermediate sampling interval.
